(19) United States
(12) Patent Application Publication
(10) Pub. No.: US 2010/0226212 A1
(43) Pub. Date: Sep. 9, 2010

(54) Video clock radio which plays themed audio and video

(76) Inventor: Kash Gobindram, Amityville, NY (US)

Correspondence Address: Daniel P. Burke, Esq.;Daniel P. Burke & Associates, PLLC, 240 Townsend Square, Oyster Bay, NY, 11771, US

(21) Appl. No.: 12/381,188

(22) Filed: Mar. 9, 2009

(51) Int. Cl. G04C 21/16; G04B 47/00; G04C 17/00

(52) U.S. Cl. 368/10; 368/239; 368/244

(57) ABSTRACT

Alarm clocks, such as alarm clock radios, comprising a video screen wherein at a preset time, the display screen displays a video and broadcasts audio. If a user does not input a required input within a certain time after the alarm mode has started, the video and audio change to a video and audio which are less tranquil. One alarm mode is initiated with waves lapping on a tranquil seashore during a sunny morning. After a while, the video and audio transition to a violent storm with dark clouds, rain, lightening, thunder and large waves crashing onto the shore. Other themes include a couple walking in a park, a couple dancing, and a busy city scene. A “silence alarm” feature requires a user to input correct information based on the display in response to a visual query, in order to stop or change the alarm mode.

The present invention is directed to an alarm clock which, at a preset time, displays at least one video and broadcasts audio.

### BACKGROUND

It is well known in the art to provide people with alarm clocks to help them wake up at a desired time. It is also known to provide such clocks with “snooze” features wherein the sound of an alarm will be temporarily stopped if the person wants to rest for awhile longer.

While it is helpful to provide a person sleeping with audio sounds to awaken the person from sleep, typical prior art alarms do not encourage a user to fully open their eyes and thereby become fully conscious or fully awake.

It would therefore be desirable to provide a video alarm clock wherein a user is encouraged to fully open her eyes and transition from a state of sleep to a state of full consciousness.

### SUMMARY OF THE INVENTION

Various embodiments of the present invention comprise alarm clocks, such as alarm clock radios, comprising a video screen and at least one speaker wherein at a preset time, the video clock will display a video and broadcast audio. The audio is preferably related to the video shown on the display screen. According to preferred embodiments of the present invention, if a user does not input a required input within a certain period of time of the device going into the alarm mode, the video and audio change from a first display/broadcast which is generally tranquil and soothing to video and audio which are discernibly less tranquil. According to embodiments of the present invention, the transition from audio and video which are more tranquil to audio and video which are less tranquil, can be abrupt or gradual. According to some embodiments, the less tranquil audio and video display nature, activities and/or people which are actively hostile, violent and/or exhibiting considerable animosity.

According to one audio/video alarm theme of the present invention, when the alarm mode is initiated, the video screen displays small waves lapping on a tranquil seashore during a sunny morning while the audio broadcasts the sounds of the waves and seagulls. After awhile, the video and audio transition to a violent storm with dark clouds, rain, lightening and large waves crashing onto the shore with a louder volume of corresponding sounds.

According to another audio/video alarm theme of the present invention, an initial video/audio displayed during an alarm mode shows a couple walking casually in a park holding hands with soft background nature sounds, e.g. birds singing. After awhile, the background noises become louder and noticeably less tranquil, e.g. animals screeching or squealing and the couple begins to argue vehemently.

According to a still further audio/video alarm theme, the initial alarm mode shows a couple dancing slowly to soft, soothing music in a club. This scene transitions to a couple dancing quickly with abrupt movements, in a different club, to loud, rap music.

A still further audio/video alarm theme comprises an initial alarm mode showing light, orderly traffic in a city scene, such as a New York City street scene, with a small amount of background noise from people talking and cars honking. As time goes on, the street noises grow much louder, with louder honking, people yelling and more cars arranged in a disorderly, chaotic gridlock.

Preferred embodiments offer a user a choice of different themes for display/broadcast during the alarm mode. As noted above, such themes can include, for example, a seashore, a couple walking in a park, a couple dancing, or traffic moving in a city.

Another aspect of the present invention requires a user to accurately answer a question from information appearing visually on the video screen in order to return the clock from the “alarm” mode to the “time” or “photo” mode.

### BRIEF DESCRIPTION OF THE DRAWINGS

FIG. 1 is an upper perspective view of a radio alarm clock of one embodiment of the present invention in an alarm mode.

FIG. 2 is a top view of the embodiment of FIG. 1 in a normal time mode.

FIG. 3 is a perspective view of the alarm clock of FIG. 1 displaying a second audio/video alarm theme, i.e. a tranquil beach/ocean scene.

FIG. 4 is a perspective view of the embodiment of FIG. 3 after the audio and video have transitioned to display a violent storm.

FIG. 5 is a perspective view of the alarm clock of FIG. 1 displaying a second audio/video alarm theme, i.e. a couple slowly dancing.

FIG. 6 is a view of the embodiment of FIG. 5 with a couple dancing faster and to louder music.

FIG. 7 is a perspective view of the alarm clock of FIG. 1 displaying a third audio/video alarm theme, i.e. showing a couple holding hands walking in a park.

FIG. 8 shows the embodiment of FIG. 7 after the scene has become less tranquil and the couple is arguing vehemently.

FIG. 9 is a perspective view of the alarm clock of FIG. 1 displaying a fourth audio/video alarm theme, i.e. with light traffic and background noises.

FIG. 10 illustrates the embodiment of FIG. 9 after the traffic and background noises have transitioned to a louder, more intense, chaotic scene with gridlock.

FIG. 11 illustrates another embodiment of the present invention useful with the embodiment illustrated in FIGS. 9 and 10.

FIG. 12 illustrates another embodiment of the present invention useful with the embodiments illustrated in FIGS. 5 to 8.

### DETAILED DESCRIPTION

The various embodiments of the present invention are directed to alarm clocks. comprising suitable user input controls, at least one audio speaker and a video screen designed to play at least one and most preferably a plurality of sequentially orchestrated videos and audio at predetermined “alarm” times. The video displayed on the screen may have a central theme which preferably remains generally the same but the character of both the video and audio changes from one of generally soothing, peaceful tranquility and harmony to one of disharmony, tumult, chaos and/or vehement animosity. The video and accompanying audio shown on the screen preferably become discernibly more intense, more turbulent and/or increasingly exhibiting greater animosity as time passes from the start of the alarm cycle. The sound played through the audio speakers preferably corresponds to the video. The video can change fairly rapidly, e.g. over a few seconds, or more gradually, e.g. over a minute or more. In any event, the video is designed to encourage the user to open her eyes.

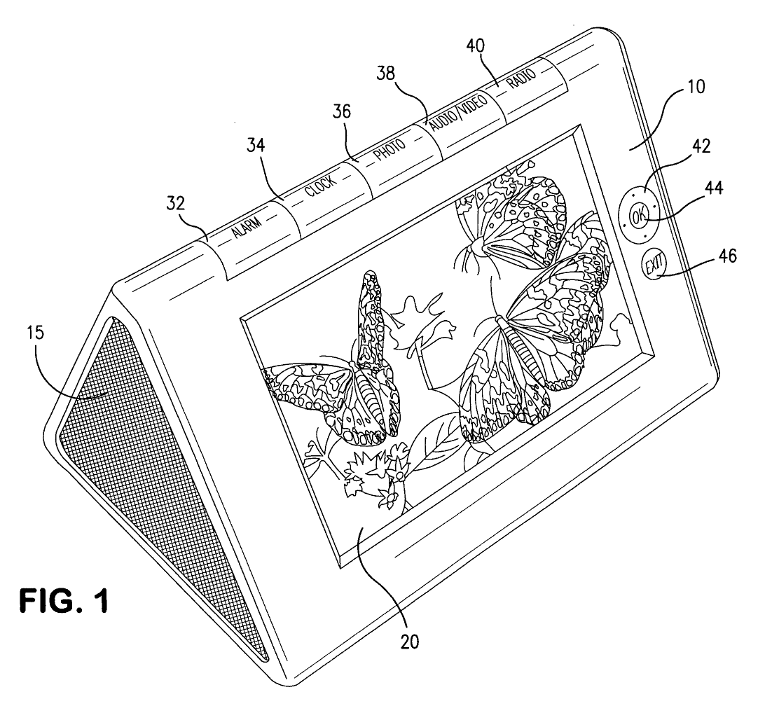

FIG. 1 illustrates one embodiment of the present invention wherein an alarm clock 10 comprises two audio speakers 15 on the ends of the housing (only one is shown), a video screen 20 and suitable user input controls. The illustrated controls comprise an ALARM button 32, a CLOCK button 34, a PHOTO button 36, a AUDIO/VIDEO button 38, a RADIO button 40, a SELECTOR ring 42, a SELECT button 44 and an EXIT button 46. Operation of the clock radio is controlled during, control/input modes described below. During the input of various controls, SELECTOR ring 42 allows a user to move between different options appearing on the video screen 20, while SELECT button 44 allows a user to select a highlighted option, similar to an “Enter” button on a computer. EXIT button 46 causes the screen to exit the control/input mode and default to a photo frame mode during which stored photos are displayed.

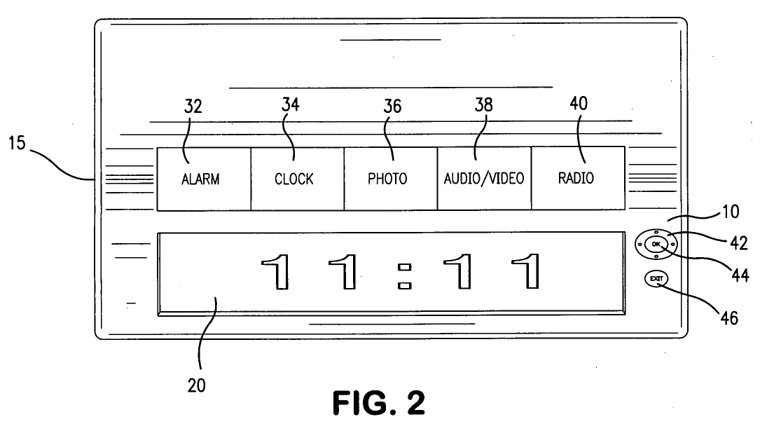

During normal operation, video screen 20 will display the time of day as shown in FIG. 2. A user wishing this mode when another non-alarm mode is displayed will simply depress the CLOCK button 34. If, alternatively, the user wishes to display one or more photos stored within the clock radio on a memory device (not shown), the user simply depresses the PHOTO button 36. Optionally, depression of the PHOTO button 36 will initially bring up a control/input display allowing a user to select one of a plurality of photos or a slide show by responding to prompts on video screen 20 and by using SELECTOR ring 42 and SELECT button 44. Similarly, a user can operate the radio function of the alarm by initially depressing RADIO button 40 which will result in the display of a control/input screen with various radio functions, such as the current radio station, a plurality of preset buttons, volume control and other common radio functions. Again, through the use of SELECTOR ring 42 and SELECT button 44, a user can control the radio functions of the device.

Alternatively and/or in addition to providing for user control/input with the illustrated buttons, SELECTOR ring 42 and SELECT button 44, video screen 20 is preferably a touch screen which allows user input simply by touching icons or other indicia displayed on various portions of video screen 20.

In order to activate the alarm feature of the illustrated clock radio, a user initially depresses ALARM button 32 which provides the user with the option of inputting various controls via a touch screen 20 or through SELECTOR ring 42 and SELECT button 44. Initially, the user has the option of turning the alarm feature on or off. The user is then preferably provided with several options, including waking up to a radio station, at least one audio/video, or a buzzer. If the user selects to wake up to a video, then the user is preferably provided with the option of selecting from a plurality of video/audio themes such as the illustrated ocean theme, a dancing couple, a couple walking in a park, or a New York City street scene. The user is also provided with the ability to input the desired time at which the alarm mode will commence.

AUDIO/VIDEO button 38 also acts as a demo button wherein the user of this alarm clock can depress AUDIO/VIDEO button 38 in order to demonstrate the available audio/videos to a friend or to simply view the available audio/video selections stored within alarm clock 10. An input port, such as a USB port (not shown), is also provided to allow a user to download additional audio/video selections which can be made available, for example, on the world wide web.

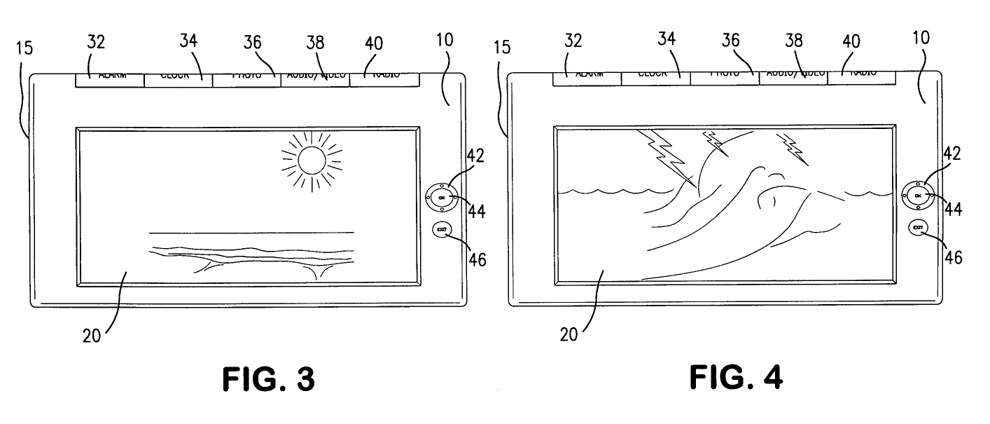

The embodiments described below and illustrated in FIGS. 3-12 have similar input controls and/or touchscreens. Additionally, each of the video alarm clocks either comprise or are connected to a source of power, such as a disposable or rechargeable battery, or a source of AC power with an electrical cord (not shown).

FIG. 1 illustrates an initial alarm mode of this embodiment of the present invention wherein the video screen 20 displays a tranquil, tropical rainforest scene theme comprising foliage and fluttering butterflies.

FIG. 2 is a top view of the embodiment of FIG. 1, but in the clock mode wherein screen 20 is displaying the time of day.

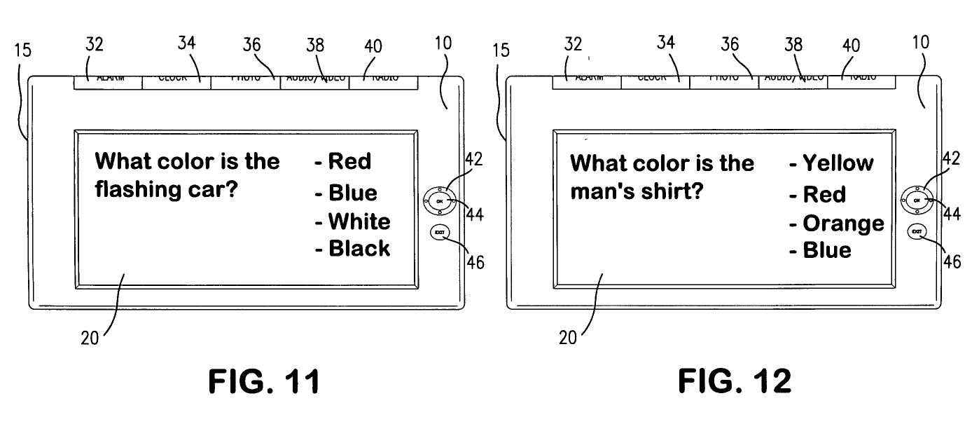

FIGS. 3 and 4 illustrate an alternative embodiment of the present invention wherein the video screens 120 are displaying a beach scene. Both FIG. 3 and FIG. 4 are in the alarm mode. In FIG. 3, the video screen 20 is displaying a tranquil ocean scene during a sunny day wherein small waves from a calm ocean are lapping gently onto the shore. Sounds corresponding to a tranquil ocean such as sounds of small waves lapping on the shore and seagulls crying off in the distance are broadcast through speakers 15. According to this embodiment of the present invention, if the person does not input predetermined controls, i.e. by depressing button 44, the video display and accompanying sound transitions into a violent thunderstorm with lightening bolts and large waves crashing down in a violent, tumultuous scene as illustrated on video display 20 in FIG. 4. Corresponding sound at a louder volume including the sound of rain hitting water, loud cracks of thunder accompanying the display of lightening, and the sounds of large waves crashing are broadcast through speakers 15. If desired, for purposes of the enhanced “silence alarm” feature described below in relation to FIGS. 11 and 12, a boat can be added to the video of this ocean theme.

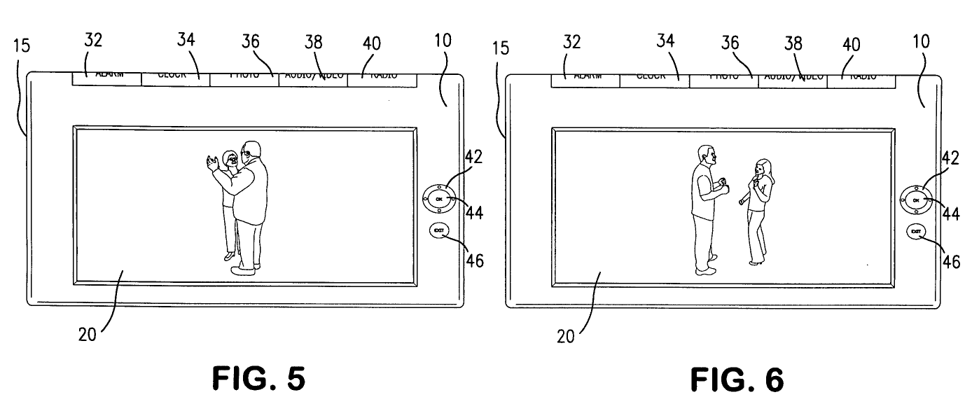

FIGS. 5 and 6 illustrate an alternative audio/video alarm theme of the present invention wherein in the initial, tranquil alarm mode, video screen 20 shows a mature couple dancing slowly while audio speakers 15 play slow, quiet music. In the absence of required user input, the video shown on display 20 and accompanying audio from speaker 15 transition to a couple dancing much faster to a much faster, louder thumping beat, e.g. a rap song.

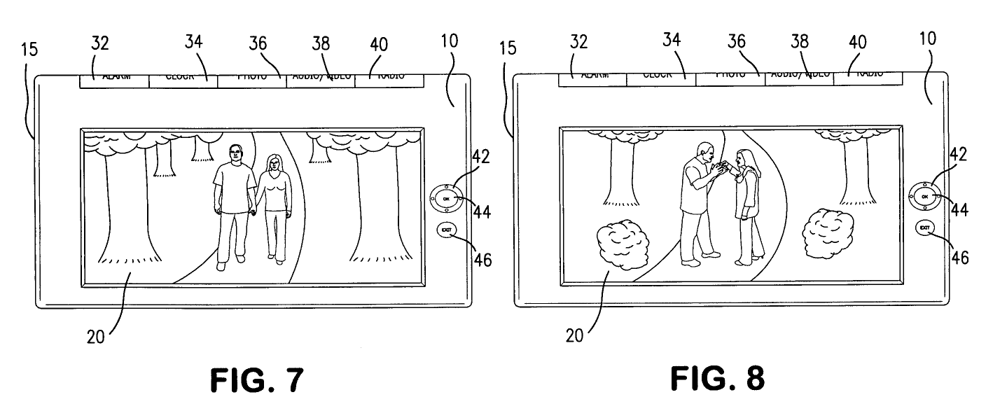

FIGS. 7 and 8 illustrate a still further audio/video alarm theme of the present invention wherein in an initial alarm mode, a couple walks peacefully through a park along a quiet path to accompanying sounds of birds chirping. If the alarm mode is permitted to continue for at least a predetermined length of time, e.g. 30 seconds, the couple starts to disagree, then they stop walking, face each other, and engage in an argument of growing intensity which turns to vehement argument and gesticulations with corresponding dialog expressing elevating levels of animosity. Concurrently, the background noises preferably become noticeably less tranquil, for example with birds screeching, raccoons squealing, and dogs barking viciously.

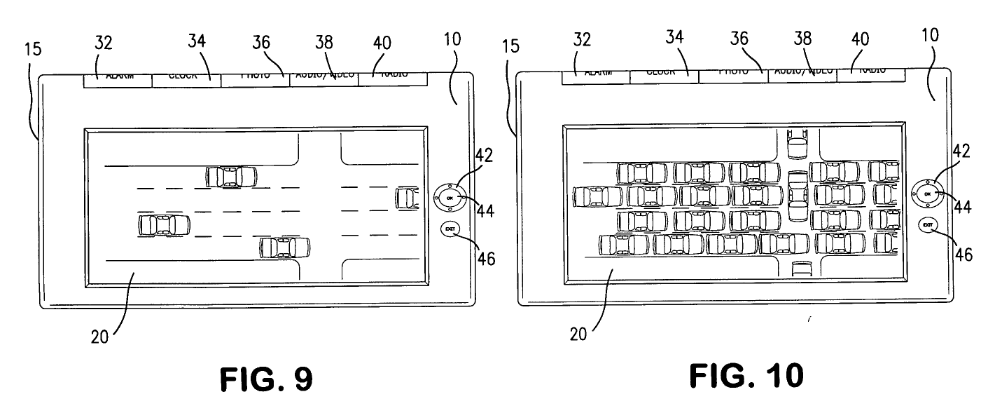

FIGS. 9 and 10 illustrate a further embodiment wherein in the initial alarm mode shown in FIG. 9 a few cars are driving peacefully along a city street while audio speaker plays far off background city noises such as an occasional car honking, car and bus engines running and partially muted sounds of people conversing. The subsequent video display shown in FIG. 10 illustrates a chaotic scene of gridlock wherein cars in and around an intersection have effectively blocked each other causing a complete standstill, which is displayed to accompanying loud, frequent angry honking, drivers yelling out of their windows at other cars, and threatening other drivers with physical harm.

The aforementioned alarm modes will continue to play until a user has input a required input which will return the alarm clock to either the time mode or the photo mode. According to one aspect of the present invention, the alarm can be silenced simply by pressing SELECT button 44 on the front of the alarm clock.

FIGS. 11 and 12 illustrate enhanced “alarm silence” modes which are caused to appear on video screen 20 when a user depresses SELECT button 44 during the alarm mode. In order to silence the alarm, the user must correctly answer a question which appears on video screen 20. For the “alarm silence” mode displayed in FIG. 11, a car displayed during an alarm mode is caused to flash on the video screen 20. As shown in FIG. 11, a user must correctly identify the color of the flashing car shown in a city traffic scene, for example, either of those shown in FIGS. 9 or 10. The text of the question and choices for responses may be overlaid on the display of the traffic scene so that the user can still see the flashing car. According to the “alarm silence” display in FIG. 12, a user is simply requested to properly identify the color of the man's shirt. Again, this question and answers can be overlaid on a screen comprising a man, such as one of screens shown in FIGS. 5-8.

While the transitioning displays are the preferred embodiments of the present invention, other embodiments of the present invention simply comprise a scene wherein the general tone and character of the video display and audio broadcast do not change. Also, while the illustrated embodiments have buttons for inputs, it is also within the scope of the present invention to simply have a touchscreen wherein all inputs are controlled on the touchscreen. The actual electronics and software utilized to provide the functionality of the various aspects of the present invention described herein are within the level of one of ordinary skill in the art who has reviewed the present description and drawings, and are, therefore, not set forth in detail herein.

According to another aspect of the present invention the transition to a more turbulent video/audio broadcast is stopped and the initial scene from the alarm mode continues to be displayed if a user enters predetermined input. For example, if a user answers a question, such as a question shown in FIGS. 11 and 12 correctly, then rather than returning to a time mode or a photo display mode, the audio/video can be programmed to return to the initial alarm mode audio/video. The continued display of the initial alarm mode audio/video scene can be displayed indeterminately or can function as a “snooze” feature wherein this scene will be displayed for a predetermined and/or programmable length of time, e.g. 5, 10 or 15 minutes, after which the audio/video of the less tranquil scene will be initiated.

1. An alarm clock comprising:
a timer;
a display device comprising a video display screen and at least one audio speaker;
means for providing at least first signals to said display device during an alarm mode, said first signals corresponding to a first scene, and subsequent signals during an alarm mode, said subsequent signals corresponding to a second scene which is discernibly less tranquil than said first scene.

2. An alarm clock according to claim 1 wherein said second scene comprises more animosity than said first scene.

3. An alarm clock according to claim 2 wherein sound is broadcast through said speakers during said first scene and during said subsequent scene and wherein sound broadcast during said second scene is louder than sound broadcast during said first scene.

4. An alarm clock according to claim 1 wherein said second scene is more violent than said first scene.

5. An alarm clock according to claim 4 wherein sound is broadcast through said speakers during said first scene and during said subsequent scene and wherein sound broadcast during said second scene is louder than sound broadcast during said first scene.

6. An alarm clock according to claim 1 wherein the display of said second scene is initiated a pre-determined length of time after an alarm is initiated.

7. An alarm clock according to claim 1 further comprising means for receiving user input, after an alarm is initiated, which continues the display of said first scene and prevents the display of said second scene.

8. An alarm clock according to claim 1 further comprising means for receiving user input, after an alarm is initiated, which reverts to the display of said first scene and prevents the display of said second scene.

9. An alarm clock according to claim 1 wherein said first scene and said second scene have a common theme.

10. An alarm clock according to claim 9 wherein said theme comprises a shoreline.

11. An alarm clock according to claim 9 wherein said theme comprises a couple in a park.

12. An alarm clock according to claim 9 wherein said theme comprises a couple dancing.

13. An alarm clock according to claim 9 wherein said theme comprises a city street scene.

14. An alarm clock according to claim 1 further comprising means for displaying a query to a user during an alarm mode, and wherein a user must input a correct response in order to stop said alarm mode.

15. An alarm clock according to claim 14 wherein said query is based upon visual information displayed on said video display.

16. An alarm clock according to claim 1 further comprising means for displaying a query to a user during an alarm mode, and wherein a user must input a correct response in order to change said alarm mode.

17. An alarm clock comprising:
a timer;
a display device comprising a video display screen and at least one audio speaker; and
means for providing signals to said display device during an alarm mode.

18. An alarm clock according to claim 17 further comprising means for displaying a query to a user during an alarm mode, and wherein a user must input a correct response in order to stop said alarm mode.

19. An alarm clock according to claim 19 wherein said query is based upon visual information displayed on said video display.

20. An alarm clock according to claim 17 further comprising means for displaying a query to a user during an alarm mode, and wherein a user must input a correct response in order to change said alarm mode.
